(19) United States
(12) Patent Application Publication
(10) Pub. No.: US 2010/0299161 A1
(43) Pub. Date: Nov. 25, 2010

(54) SYSTEM AND METHOD FOR ADMINISTERING SUBROGATION RELATED TRANSACTIONS

(75) Inventors: R. Bradley Burdick, West Hartford, CT (US); Thomas F. Morgan, Wethersfield, CT (US); Jeanne T. Peckham, Columbia, SC (US); Donald Pierce, Enfield, CT (US)

Correspondence Address: Howard IP Law Group, P.O. Box 226, Fort Washington, PA, 19034, US

(73) Assignee: HARTFORD FIRE INSURANCE COMPANY, Hartford, CT (US)

(21) Appl. No.: 12/645,801

(22) Filed: Dec. 23, 2009

Related U.S. Application Data
(60) Provisional application No. 61/180,512, filed on May 22, 2009.

(51) Int. Cl. G06Q 40/00; G06Q 50/00; G06F 15/16

(52) U.S. Cl. 705/4; 706/52; 709/204

(57) ABSTRACT

A computer system for administering an intelligent subrogation transaction includes a processor and a memory in communication with the processor. The processor may be configured to prompt a user for data regarding a new subrogation transaction, store received data, access from the memory data related to existing subrogation transactions, perform subrogation related calculations including application of one or more predictive and regulatory business rules; provide an output signal comprising data indicative of a response based on a result of the application of the business rules; receive user instructions for preparation of a communication including data indicative of the response, and provide the prepared communication.

### RELATED APPLICATIONS

This application claims the benefit under 35 U.S.C. 119(e) of U.S. Provisional Patent Application Ser. No. 61/180,512, filed May 22, 2009, which application is incorporated herein by reference in its entirety for all purposes.

### FIELD OF INVENTION

The present invention relates to computer systems, and particularly to computer systems for administration of subrogation related transactions.

### BACKGROUND

Subrogation of insurance claims relates to the making of demands for contribution to coverage of covered events between insurance carriers, and the responses to those demands. By way of example, subrogation-related transactions are often performed to allocate the losses associated with automobile accidents between carriers. An automobile accident may take place between two vehicles having owners with liability insurance coverage provided by two different insurance carriers. The owner of each vehicle may submit claims to the owner s insurance company for coverage of costs of repair of the vehicles and related expenses, such as expenses of rental vehicles until the owners vehicles have been repaired. After the accident, the owner of the damaged vehicle has the right to seek damages from a responsible party, such as the owner or driver of the other vehicle. The insurance carrier stands in the shoes of the insured, and has the right to seek damages from the responsible party. The substitution of the insurance carrier for the insured is known as subrogation. Each insurance carrier will typically investigate the accident, such as by interviewing its insured and possibly other witnesses, reviewing police reports and having its representative, usually an adjuster, evaluate the damaged vehicle. Each of the insurance carriers has obtained the identity of the other carrier from the exchange of insurance information by the owners at the accident scene. At least one of the insurance carriers may then conclude that the other carrier is responsible for damage. For example, the owner may state that the other vehicle failed to stop at a stop sign and collided with the owner s vehicle. The insurance carrier will typically prepare a letter to the other carrier, demanding payment of a particular amount of money, with documentation of the grounds for liability and the amount of the damages. For example, the documentation may include a copy of a police report, and the documentation of the amount may include a copy of an itemized bill from a body shop that performed the repairs. The insurance carrier that receives the demand will then evaluate the demand, and decide how to respond. The recipient insurance carrier may agree with liability and the amount, and agree to pay the entire amount. The recipient insurance carrier may agree with liability but disagree with the amount. For example, the body shop s charges may be unusually high for the work performed. In that case, the recipient insurance carrier may respond with a counter offer for a smaller amount than was set forth in the demand. The recipient may disagree with liability. For example, the recipient insurance carrier may note that the recipient carrier s owner stated that the other car failed to stop at a stop sign. In that event, the recipient may respond by rejecting the demand in its entirety.

If the insurance carriers are unable to agree on which company is liable, or on the amount to be paid, the insurance carriers may have the matter resolved by arbitration, or by litigation. However, both arbitration and litigation are expensive, and may involve time of the insureds and others to appear as witnesses. Moreover, insurance carriers are frequently both demanding payment and receiving demands for payment from the same insurance carrier, for different underlying events, such as automobile accidents, simultaneously. For these reasons, consistent and thorough demands and responses to demands are important to insurance carriers.

Numerous items of information and documents are typically associated with an underlying loss event, is typically involved. The information and documents involved include, by way of example, data regarding coverage, such as effective dates of policies, statements of witnesses, police reports, adjuster s reports, photographs of damaged vehicles and other property and estimates and invoices from body shops. Maintenance of information and documents associated with an underlying loss event involves a sophisticated documentation system.

### SUMMARY

In one embodiment, a computer system for administering a subrogation transaction related to a loss event has a processor and a memory storage device in communication with the processor. The processor configured to: access from the memory storage device data relating to the loss event; perform subrogation related calculations based on the accessed loss event data and responsive to a first regulatory business rule and a first predictive business rule; determine, based on the calculations, a recommendation for a communication between insurance carriers including at least an amount, and provide an output signal for display of the recommendation on a user-accessible device.

In an embodiment, a computer system for administration of subrogation related transactions based on associated loss events, has: an intake module configured to receive data relating to the loss events; a triage module configured to run regulatory business rules and predictive business rules on the received loss event data and provide recommendations to a user based on results of running the business rules; a communications preparation module configured to prompt a user to select template communications and provide inputs including data based on the received loss event data to create outgoing communications; and a communications transmit module to transmit the outgoing communications.

In an embodiment, a computer-implemented method for administering subrogation related transactions involving loss events, includes: receiving data relating to at least one of the loss events by an intake module, and storing the received loss event data in a database; applying regulatory business rules and predictive business rules to the received loss event data, and providing, based on results of the applying, recommendations to a user, by a triage module; creating outgoing communications based in part on the loss event data, by a communications preparation module; and transmitting the outgoing communications by a communications transmit module.

In an embodiment, a computer-readable medium for processing subrogation related transactions has a plurality of instructions thereon which, when executed by a processor, cause the processor to: receive data relating to a loss event and store the received data in a database; access the received data, apply to the received data regulatory business rules and predictive business rules, and, based on an outcome of the application of the business rules, provide at least one recommendation related to the loss event to a user, the recommendation including at least a proposed payment amount; prompt a user to select a template communication and provide data for populating fields in the selected template communication, the provided data based on the received loss event data, to create an outgoing communication; and transmit the outgoing communication.

In an embodiment, a computer system for processing of demand side subrogation transactions, has: an intake module configured to receive data relating to a loss event, the data including at least a responding carrier; a triage module configured to apply regulatory business rules and predictive business rules to the received loss event data and provide recommendations to a user for preparation of a demand to the responding carrier based on results of running the business rules; a communications preparation module configured to prompt a user to select template communications and populate the selected template communications with data based on the received loss event data to create outgoing communications, the outgoing communications including at least demands; and a communications transmit module to transmit the outgoing communications.

In an embodiment, a computer system for processing of response side subrogation transactions, includes: an intake module configured to receive data relating to a demand, the data including loss event data and a demanding carrier; a triage module configured to apply regulatory business rules and predictive business rules to the received demand data and provide recommendations to a user for preparation of a response based on results of applying the business rules; a communications preparation module configured to prompt a user to select template communications and populate the selected template communications with data based on the received loss event data to create responses; and a response transmit module to transmit the responses.

In an embodiment, a computer system for administration of subrogation related transactions based on associated loss events, includes: an intake module configured to receive data relating to the loss events; a triage module configured to run regulatory business rules and predictive business rules on the received loss event data and provide recommendations to a user based on results of running the business rules; a communications preparation module configured to create outgoing communications; a communications transmit module configured to transmit the outgoing communications; and a monitoring module configured to store subrogation related transaction data, review response results, compare response results to results expected according to application of the business rules, and generate recommendations for updating the business rules based on the monitored response results.

### BRIEF DESCRIPTION OF THE FIGURES

FIG. 1 is a schematic diagram of an exemplary computer system for implementation of a method and system of the invention.

FIG. 2 is a schematic diagram of an exemplary network for implementation of a method and system of the invention.

FIG. 3 is a schematic diagram illustrating an exemplary computer system for implementation of a method and system of the invention.

FIG. 4 is a schematic diagram showing an exemplary computer system for implementation of a method and system of the invention.

FIG. 5 is a process flow diagram identifying modules for performing steps in a method.

FIG. 6 is a block diagram showing components in a system of the invention.

FIG. 7 is a screen shot of a listing of claims in a system of the invention.

FIG. 8 is a screen shot of an alternative listing of claims.

FIG. 9 is a screen shot of an initial intake module screen.

FIG. 10 is a screen shot of a further intake module screen.

FIG. 11 is a screen shot of a screen of an intake module for a particular type of claim.

FIG. 12 is a screen shot of a screen showing multiple responding carriers.

FIG. 13 is a screen shot presented to a responding carrier.

FIG. 14 is a screen shot showing recommendations and history data.

FIG. 15 is a screen shot showing documents related to a claim.

FIG. 16 is a screen shot showing a recommendation of partial payment.

FIG. 17 is a screen shot providing a user with message transmission options.

FIG. 18 is a screen shot providing a user with options for message contents.

FIG. 19 is a screen shot providing a user with a preview options for messages.

### DETAILED DESCRIPTION

It is to be understood that the figures and descriptions of the present invention have been simplified to illustrate elements that are relevant for a clear understanding of the present invention, while eliminating, for the purpose of clarity, many other elements found in typical computer systems and methods for administration of subrogation related transactions. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein.

The Figures below are block diagrams of a dynamic and intelligent subrogation administration and processing system according to some embodiments of the present invention. The system administers an intuitive, efficient and intelligent tool for providing intelligent and efficient subrogation processing having an easy to use interface. Embodiments of the invention may provide a subrogation resolution system which can efficiently and intelligently manage both demand and response side transactions to resolve and manage transactions from the intake, triage, review, communication preparation, issuance and tracking/reporting perspectives. Embodiments of the invention may include a subrogation resolutions system which can efficiently and intelligently manage claims. As shown, an intelligent subrogation system includes at least one computer server for response settlement/rules processing and other functions which is in communication with a number of client devices or entities via a communications network. The devices may include, for example, servers, personal computers, facsimile machines, email servers, and/or web servers and may be operated by entities and individuals, including, by way of example, insurance companies, insurance company representatives, third party subrogation providers, etc. Note that any of the devices described herein may include a Personal Computer (PC), a portable computing device such as a Personal Digital Assistant (PDA), a smart phone, or any other appropriate storage and/or communication device to perform such functions as displaying, storing, communicating, analyzing and exchanging insurance-related information, employing one or more web sites and/or communication networks. As used herein, devices (including the participant/client devices) may exchange information via any communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Each module or component within the system may be connected over a network or may be directly connected. One skilled in the art will recognize that the terms “network,” “computer network,” and “online” may be used interchangeably and do not imply a particular network embodiment or topography. In general, any type of network (e.g., LAN, WAN, or Internet) may be used to implement the online or computer networked embodiments of the present invention. The network may be maintained by a server or combination of servers, or the network may be serverless. Similarly, any type of protocol (e.g., HTTP, FTP, ICMP, UDP, WAP, SIP, H.323, NDMP, TCP/IP) may be used to communicate across the network. Note that any devices described herein may communicate via one or more such communication networks.

A computer server may be in further communication with or coupled to one or more data sources such as one or more rules databases, bodily injury databases, discovery databases, response settlement databases, state insurance department databases, state property databases, motor vehicle databases, etc. to facilitate the provision of the insurance subrogation processing. Although a single server is shown, any number of servers may be included in the system. Similarly, any number of devices (and any other devices described herein) may be included according to embodiments of the present invention.

A server may comprise one or more servers adapted to receive, store, process and/or transmit subrogation related information associated with insurance companies, claimants, clients and/or data. In various embodiments, a server encompasses one or more Web servers which may be accessible to the client devices via the Internet. A web server may be a computer system which includes specialized software for delivering (serving) Web pages to Web browsers running on one or more client devices. In other embodiments, a server may encompass multiple interconnected servers. More specifically, a software infrastructure may be provided that represents multiple interconnected physical and/or virtual servers as a single logical server. The single logical server is dynamically allocated to the multiple virtual servers. Each of these virtual servers includes an operating system and a virtual machine.

A user, such as an insurance company representative, or a third party intermediary demand center representative, may operate a client device to initiate a subrogation determination or transaction with an entity such as an insurance or financial services company operating or controlling a computer server. Pursuant to some embodiments, a number of different types of client device may be used to initiate a transaction. For example, the client device may be a telephone, including a smart phone, a handheld, terminal, portable or desktop computer, a kiosk, a wireless handset, or the like. Each client device may initiate communication with a server via a communications network. Communications network may include one or more of, or a combination of, a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Client devices may communicate via one or more such communication networks.

It is contemplated that client devices may also include one or more input devices, such as a mouse and/or a keyboard, for accepting inputs from a user. Similarly, one or more output devices, such as a monitor and/or a printer, may be provided within, or be accessible from, the client device. The system according to embodiments of the invention is configured to manage and administer intelligent, accurate and efficient subrogation transactions in a friendly and easy to use environment as discussed in more detail later herein.

In the examples of process flows and data elements set forth below, the process flows and data elements are illustrative of embodiments. Terms such as ‘shall, ‘will and ‘required are illustrative of exemplary embodiments of the invention, and are not limiting. By way of non-limiting example, in other embodiments, data elements indicated as mandatory may be omitted, and data elements not listed herein may be added. References to particular organizations and products, such as Trumbull Services and Subroshare, are merely exemplary and are not limiting.

A challenge in the field of subrogation is in determining appropriate offers, counter offers and acceptances. A further challenge is in collecting and maintaining the large volumes of data and numbers of documents associated with claims between insurance carriers.

Subrogation transactions, such as demands for payment, offers of payment, counter offers, denials of responsibility, and other transactions, arise from underlying loss events. Loss events include events such as accidents; fires; injuries to individuals, also known as personal injuries; damage to real property, such as homes and buildings, through causes such as fires, water damage, and other causes; and damage and loss of personal property, such as through fire, theft, or other causes, and other causes. The responsibility of carriers for loss events may arise through any type of insurance policy, including automotive insurance, homeowners insurance, workers compensation, business comprehensive general liability insurance, and other types of insurance.

In an embodiment, a system and method provide for the use of business rules and a database containing historical data concerning outcomes to provide assistance to the user in determining appropriate offers and counter offers and the likelihood of success of various categories of responses. A category of business rules employed in a system according to the invention may be described as regulatory business rules. Regulatory business rules include definite rules and limits imposed by such factors as terms and conditions of insurance policies and state rules and regulations. Regulatory business rules include, by way of example, applicable coverage limits under policy terms or state statute or regulation, policy term dates, identities of insureds, and statutes of limitations. In an example, application of a regulatory business rule to loss event data may include comparing a date of a loss event included in the loss event data to policy term dates. If the loss event is outside the policy term dates, then the result of application of the business rule is that there is no liability. A system for response side processing may generate to a user on a display a recommendation for complete denial of a demand, based on the result of application of the regulatory business rule.

Predictive business rules include rules for predicting or estimating likely parameters and outcomes. Predictive business rules may include rules based on past conduct of a carrier, for example. For example, a predictive business rule may provide, based on past experience that demands from Carrier A are well-documented and, accordingly, that demands from Carrier A up to a certain amount, such as $1000, do not require detailed review. By way of further example, a predictive business rule may provide, based on past experience that demands from Carrier B are poorly documented, that all demands from Carrier B require detailed review. As a result of application of the foregoing exemplary regulatory and predictive business rules, a system may determine a recommended next step in response side processing; for example, for a demand from Carrier A for a payment of $900 for a loss event within the policy term, the system may determine a recommendation of payment in full, and display on a user-accessible device, such as a screen of a client computer system, a recommendation to pay the $900 demand from Carrier A in full.

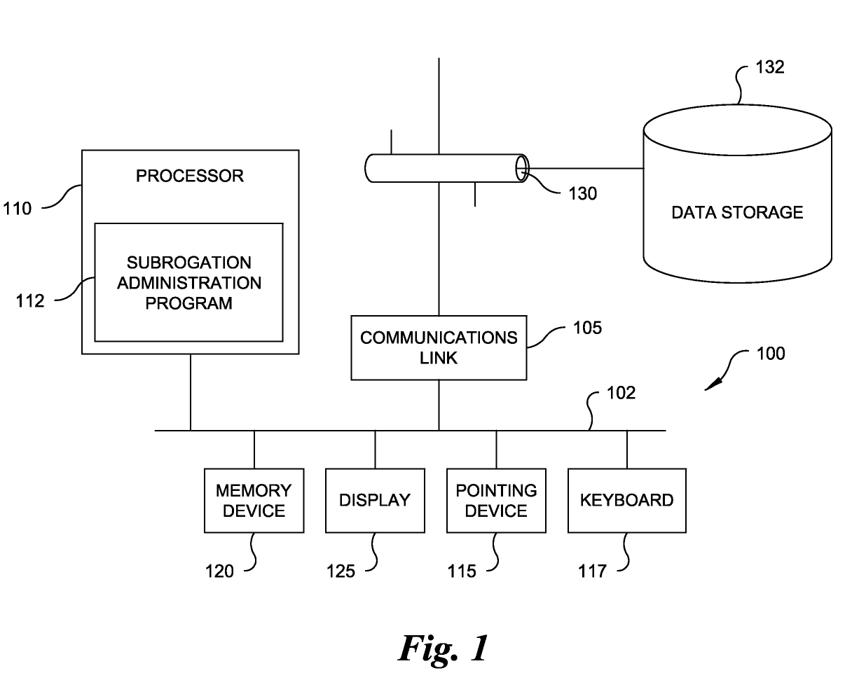

Referring to FIG. 1, an exemplary computer system 100 for use in an implementation of the invention will now be described. In computer system 100, processor 110 executes instructions contained in programs such as subrogation related transaction administration program 112. Computer system 100 may server as an administration module. Programs may be stored on suitable media, such as optical or magnetic disks, fixed disks with magnetic storage (hard drives), tapes accessed by tape drives, and other storage media. Processor 110 communicates, such as through bus 102 and/or other data channels, with communications link 105 and memory device 120, receives data from user inputs such as pointing device 115 and keyboard 117, and provides data to outputs, such as data to video drivers for formatting on display 125. Memory device 120 is configured to exchange data with processor 110, and may store programs containing processor-executable instructions, and values of variables for use by such programs. Memory device 120 may have stored therein data such as carrier data, claim data, past offers and responses, templates for letters and other communications, and other data. In an embodiment, inputs may include user interfaces, including workstations having keyboards, touch screens, pointing devices such as mice, or other user input devices, connected via networked communications to processor 110. Outputs may include displays and printers. Communications link 105 may communicate with remote sources of information, and with systems for implementing instructions output by processor 110, via LAN 130. LAN 130 is merely exemplary, and communication may be by one or more of suitable communication methods, including over wired or wireless local area networks and wide area networks, and over communications between networks, including over the Internet. Any suitable data and communication protocols may be employed. Data storage 132, which may include a wide variety of data acquired and processed in accordance with embodiments, is accessed via LAN 130. Data storage 132 may include data concerning carriers, claims, and other data.

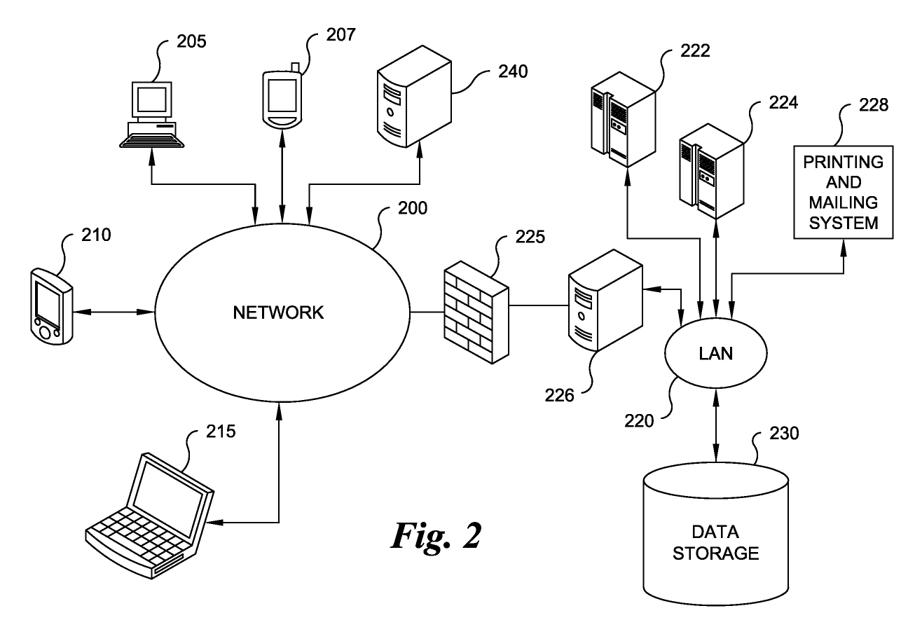

Referring now to FIG. 2, a schematic diagram of a network arrangement including a client server arrangement for implementation of a method and system in accordance with an embodiment of the invention is presented. In the arrangement of FIG. 2, client devices 205, 210, 215 may be connected via network 200 to server 226. In an implementation, client devices 205, 210, 215 may be personal computers running an operating system such as Windows XP, Windows Vista, or Apple Tiger, thin client devices, portable devices such as personal digital assistants (running the Palm OS, by way of example), cell phones, including web-enabled smart phones, or other devices. Software running on client devices may include general purpose browser software, applications software specific to subrogation-related transactions, such as application software for smart phones specifically intended for use in connection with assertion and resolution of claims between insurance carriers, and other software. Client devices may be operated by carrier personnel, insurance agents or brokers, or representatives of third party firms engaged to provide claim assertion and resolution services on behalf of carriers. Network 200 may be or include the Internet, a corporate intranet, wireless and wired communications channels, and other network features. Firewall unit 225 may be configured to provide data security services with respect to systems and networks, including exemplary server 226 and LAN 220. Firewall unit 225 may include distinct hardware, including a processor and memory device, to provide virus protection and user authentication services, for example. In an embodiment, the devices protected by firewall unit 225 may be systems of an insurance carrier. Server 226 may have a processor that is configured or configurable to receive data, such as loss event data and other data pertinent to subrogation transactions. Server 226 may receive requests to generate demands, responses, subrogation settlement agreements and other documents, and may pass those requests, such as via LAN 220, to another computer system, such as mainframe system 222, which may be based on the IBM/360 platform. Mainframe system 222 may in response to a request and suitable data generate appropriate documents, such as demands, responses and settlement agreements, which may then be passed in electronic format via LAN 220 to printing and mailing system 228. Printing and mailing system 228 may print and mail documents provided by mainframe system 222. In an embodiment, contracts and related documents may be transmitted in electronic form to a client device of an employee of another insurance carrier. Server 226 may run various programs that serve to initiate and monitor sessions with one more of client devices 205, 206, 207. Server 226 may serve for display on client devices 205, 210, 215, prompts to the user for data required to proceed with subrogation transactions.

Server 226 may implement instructions in programs that provide a web front end, linked to back end computer systems for implementing administration of subrogation-related transactions. For example, mainframe 224 may include programs for administration of subrogation related transactions. Data storage 230 may include data received in demands for subrogation, and historical data regarding demands for subrogation. Server 226 may, by way of example, provide a user with listings of status of subrogation-related transactions, and permit a user to select a response from among a menu of, and be configured to receive signals from user device 205, 210, 215 requesting such information, and to communicate such information to back end systems such as mainframe 224 and data storage 230 via LAN 220. Server 226 may in response to a request from a client device, access and serve for display on the client device data regarding subrogation related transactions.

Server 226 may also access third party systems, such as server 240. Server 240 may be a system of a third party, such as a financial institution that maintains accounts that are employed for payments to or from a carrier, or a system that maintains third party databases employed for verification and augmentation of claim data, such as vehicle identification number and vehicle title history databases.

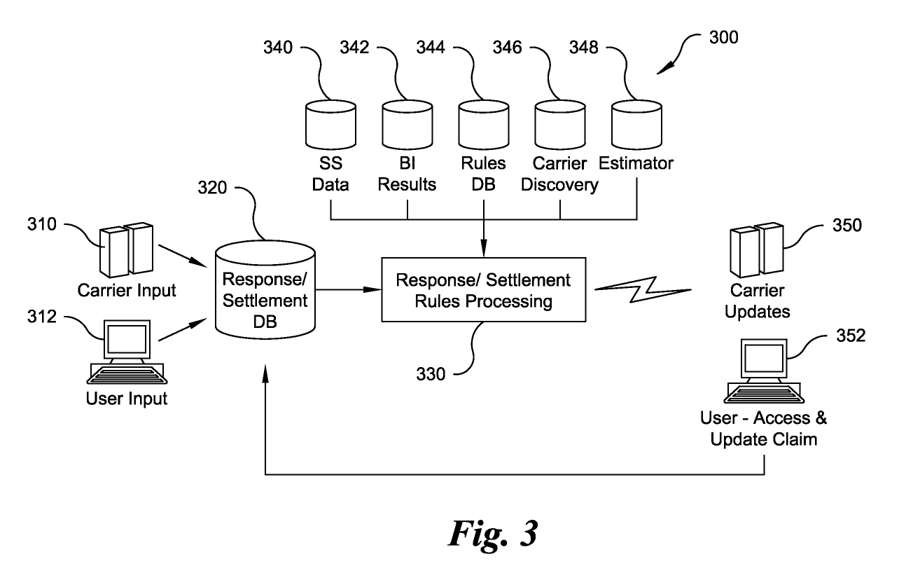

Referring to FIG. 3, an exemplary system 300 for administration of subrogation-related transactions is shown. System 300 may be implemented in an application service provider mode and provide services to a variety of carriers. Data from carriers and from individual users, including data relating to loss events, demands, responses, as well as settlement data, is received and stored in response/settlement database 300. Data is forwarded from response/settlement database 300 to rules/settlement processing engine 330. Processing engine 330 may be implemented as a server or a server-based module that applies business rules to received demands and responses. Processing engine 330 may apply both regulatory business rules and predictive business rules. In applying business rules, processing engine 330 may employ one or more sources of data. Subrogation and settlement database 340 includes data relating to past subrogation and settlement resolutions. Business intelligence results database 342 stores business intelligence data. Examples of business intelligence data include the apparent likelihood that the recipient is liable, the quality of quantification of the amount of the claim, and the typical practices of the carrier making the demand. Rules database 344 may include government-imposed rules, such as statutes of limitations applicable to tort claims in different states. Methods and systems disclosed in U.S. Pat. No. 5,991,733, which is incorporated by reference herein in its entirety, may be employed in connection with determining the likelihood of success, by way of example. Carrier discover database 346 may incorporate data specific to carriers, including contact data and history data. Estimator database 348 may include data and rules for determining accurate estimates for work that may be sought in a claim, such as repairs of damaged automobiles.

Processing engine outputs data to the user, which may include a recommendation, history data, and other data, which is then provided to a carrier database 350 and to the user 352.

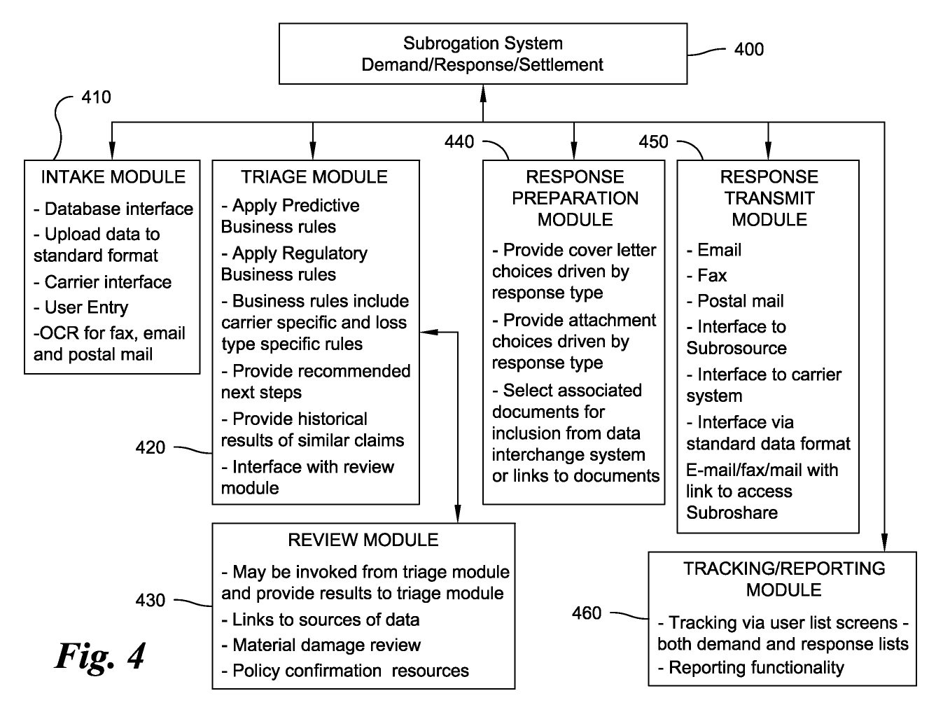

Referring to FIG. 4, a computer system 400 according to an embodiment is illustrated. In an embodiment, a subrogation transaction system 400 may include a plurality of modules, including intake module 410, triage module 420, review module 430, response preparation module 440, response transmit module 450 and tracking/reporting module 460. In general terms, intake module 410 obtains information on a new demand or response, and causes the demand or response to be added to a system database. Triage module 420 applies rules to provide a recommendation to the user for next action. Review module 430 makes tools and resources available to the user, including for example third party tools and databases for detailed claim review. Response preparation module 440 serves to facilitate creation of response letters, demand letters, and attachment of appropriate additional documents. Response preparation module 440 is an example of a communications preparation module. Response/transmit module 450 provides for output of the communication prepared using response preparation module 440 and associated data to the appropriate party utilizing an appropriate format (i.e. electronic, FAX, mail, etc.). Tracking/reporting module 460 employs business intelligence and review of current activities to monitor the appropriateness of rules employed by triage module 420 for development of recommendations. It will be appreciated that modules may be implemented as standalone units including processors, memory devices, and input/output devices, with the memory devices storing computer code which, when executed by the processors, causes the processors to perform certain steps. The processors may be said to be configured to perform those steps. Alternatively, modules may be implemented as distinct computer code which may be executed by the same processor at different times.

Intake module 410 may perform the following functions: interface to a database for writing of received data to the database, user entry of data on receipt of communications of any type; optical character recognition for upload of mail, faxes and e-mails to a database, accessing data from computer systems of other carriers, and transformation of received data to format compatible with system databases. The data received may include loss event data, such as date of a loss event, insurance policy data, insured data, type of event, description of the event, and the like. The data may include documents in electronic or paper form. The documents may include audio and video files of interviews with insureds and other witnesses, as well as reports designed for printing.

Intake module 410 permits entry of the following data types:
a. Offer Type (Response or Demand)
b. Policy Type, such as automotive, homeowners, business owners, and other types of policies available.
c. Party One Information(Information for current system user)
   i. Carrier Name, which may be auto populated by the intake module accessing user data associated with login data;
   ii. Contact First Name, which may be auto populated by the intake module accessing user data associated with log in data;
   iii. Contact Last Name, which may be auto populated by tie to log in data;
   iv. Contact Phone, which may be auto populated by tie to log in data;
   v. Contact Phone Extension, which may be auto populated by tie to log in data;
   vi. Contact E-mail Address, which may be auto populated by tie to log in data;
   vii. Contact Fax Number, which may be auto populated by tie to log in data;
   viii. Claim Number;
   ix. Insured Name;
   x. Policy Number; and
   xi. Policy State.
d. Party Two Data (Information for other party/carrier)
   i. Carrier Name (Required);
   ii. Contact First Name (Required);
   iii. Contact Last Name (Required);
   iv. Contact Phone (optional ′ required for Correspondence, if applicable);
   v. Contact Phone Extension (optional ′ required for Correspondence, if applicable);
   vi. Contact E-mail Address (optional ′ required for Correspondence, if applicable);
   vii. Contact Fax Number (optional ′ required for Correspondence, if applicable);
   viii. Contact Address (optional ′ required for Correspondence, if applicable);
   ix. Claim Number (Required);
   x. Insured Name (Optional);
   xi. Policy Number (Optional); and
   xii. Policy State (Optional).
e. Points of View Information
   i. Demanding Insured s Percentage of Liability (Required);
   ii. Responsible Party Percentage of Liability (Required);
   iii. Loss Category (Required);
   iv. Loss Description (Optional); and
   v. Total Loss (Initializes to ‘No).
f. Claim Information (All fields are required, unless otherwise indicated)
   i. Date of Loss (Required);
   ii. Loss State (Required);
   iii. Statute Date (will be system generated); and
   iv. Salvage Received (Initializes to ‘No).
g. Loss Type Information. (Shall support the addition of multiple loss types per claim. All fields are required).
   i. Loss Type ′ (drop-down list of standardized loss types)
   ii. Loss Amount (validation rules may require a positive number ′ dollars & cents)
h. Additional Information. The fields that may be presented for entry of additional information will be dependent on rules that provide results dependent on Policy Type and Loss Types selected. By way of example:
   i. Vehicle information will display for Policy Type=Auto
      1. Year
      2. Make
      3. Model
   ii. Rental information will display for Loss Type=Rental
      1. Rental Days
      2. Labor Days
i. Document Information
   i. Documents may be interfaced or uploaded.
   ii. Document links may be included within the common interface
j. Notes
   i. A field is provided for users to add notes as applicable during the demand or response processing
   ii. The intake module tags notes for inclusion in a database associated with data including:
      1. Date added
      2. User name of the individual creating the note
      3. Note content

Business rules may be applied making certain fields required or optional depending on the point in the business process flow.

The intake module may furnish data to triage module 420 during a user session. The triage module 420 may apply rules to determine if sufficient information has been received for triage module 420 to process, and may return a message to intake module having data identifying additional data to be provided. Intake module 410 may then display a message to the user identifying additional data to be provided.

The intake module 410 may include kick out rules that identify claims that cannot be processed further, and providing a message to the user that no more information is required, and further preventing the user from providing additional information. By way of example, a rule may prevent entry of data on claims having an incident date that is beyond the applicable statute of limitations.

In an embodiment, the intake module 410 may be configured to access and send queries to one or more sources of information for use in verification and enhancement of data received via the intake module. By way of example, if the intake module receives data related to a claim for subrogation involving an automobile accident, the intake module may access and query a third party database of vehicle identification number (VIN) data, or a source of data regarding vehicle history, such as ownership records, records of damage and accidents, salvage records, service records and other data, such as the CARFAX® vehicle history report service, to verify and enhance the data received via the intake module. The intake module 410 may be configured to perform comparisons of data received from a user and information obtained from a source of information, and to generate an error message if the comparison indicates that the data does not match. For example, if the received data includes a VIN, make, model and year of a vehicle, and the third party database of VIN data indicates a difference in any of make, model and year associated with the same VIN, an error message may be generated stating that there may be an error in the data. The intake module may be configured to require correction before permitting further processing. The intake module may be configured to include in the database a flag indicating the mismatch; for example, the third party database may have erroneous information; a triage module may display the flag for a user on a display, thereby prompting a user to investigate further. The intake module 410 may be configured to augment data relating to the claim received from the one or more sources of information.

Triage module 420 may apply predictive business rules and regulatory business rules to provide recommended responses. The business rules may include rules applicable throughout the insurance industry, rules that are specific to the carrier submitting the demand, and rules applicable to the specific type of loss. By way of example, for a claim including a claim for reimbursement for a rental car, the triage module may employ rental rules that provide a maximum reimbursable rental charge, including the following as variables: State, number of days, maximum number of days, and maximum rate per day. Such rental rules are examples of regulatory business rules.

The following data elements may be employed by an embodiment of triage module 420 in applying rules:
a. Carrier
b. Loss Type (standard values)
c. Loss State
d. Loss Description (standard values)
e. Liability Percentage
f. Loss Amount
g. Total Loss Indicator
h. Salvage Received Indicator

The triage module may provide as an output one of a variety of recommendations in response to a demand. In an embodiment, those recommendations include at least the following:
a. Partial Pay
b. Full Pay
c. Arbitrate
d. Deny
e. Material Damage Review

Triage module 420 may also have a capability of selecting queries, such as from a table that maps from carrier, type of loss, and other data to particular queries, and running database queries. The queries return records of similar claims, which records include outcomes, such as partial pay, full pay, arbitrate, denial, and litigation. The triage module 420 may access the outcomes, perform statistical analyses, such as determining percentages and other statistical information, and display the results in numerical and/or graphical form.

The triage module 420 may be configured to communicate with review module if a user requests a detailed review of a claim. A review module 430 may have the following functionality. The review module 430 may provide links to software tools, databases and third party resources. Exemplary types of information may include: Software to facilitate a material damage review; access to databases to confirm policy information, including dates and types of coverages; support for salvage, including databases having price data for automobile parts that may be salvaged and contact information for scrap dealers to determine pricing; a labor module containing labor time and cost data, by location, for automotive repair work; modules providing access to other applicable databases, and diagramming modules to assist in the analysis process. The review module may have access to a provider s subscription information and may be able to provide access to third party subscription software and databases over networks, including via the Internet. The review module may have access to sources of telematics data detected automatically by sensors at the time of an incident and subsequently stored in a database. For example, the telematics data may include, in the case of an automobile, speed, acceleration and deceleration, airbag deployment, driver inputs such as manipulation of steering wheel, application of brakes and gas, external air temperature, skid data detection by automatic braking systems, and location data from global positioning system devices. Such data may be automatically and continuously detected and stored in a memory device of an onboard unit of an automobile. The onboard unit may be physically recovered and have the memory data transferred to a database. Alternatively, the onboard unit may include a wireless transmitter that communicates with a network, such as a cellular telephone network, for transmission of data either periodically on a routine basis or following receipt of inputs, such as deceleration in excess of a threshold, indicative of an accident. The review module may access and present the telematics data for display on the user device. Predictive business rules may also be provided that employ telematics data. For example, predictive business rules may provide that the absence of airbag deployment indicates fraud or error in a demand if the claimed damage amount is above a threshold. The review module returns data to the triage module, which then employs the data to formulate a recommended response.

A response preparation module 440 may have the following functionality. The response preparation module may be activated by the triage module. The response preparation module includes template communications, such as stored template response cover letters. The data for inclusion in the template includes the type of response, the address of the carrier on whose behalf the letter is being sent, and the recipient data. The response preparation module 440 may permit the attachment of documents to the cover letter, including template attachments. Access may be provided to images and documents for inclusion among attachments. The images may be stored in a local database, or accessible from external systems, such as carrier databases.

A response transmit module 450 may have the following functionality. The response transmit module has access to responses prepared and stored by response preparation module 440. The response transmit module may be configured to interface with an e-mail client or server to provide e-mail transmission of the response. The response transmit module may be configured to interface with a fax server to provide image data and recipient fax number data to fax machines for fax transmission. The response transmit module may support provision of the cover letter and attachments in electronic form to a printing and mailing system for printing in hard copy and mailing, or dispatching by courier, to the recipient. The information may also be uploaded to a server through which access is permitted based on permissions, such as user identification, such as the SubroShare® subrogation portal, or third party portals, such as those implemented using SharePoint® technology. Upload of correspondence and documents to carrier systems directly may be provided.

A tracking/reporting module 460 may be configured to perform queries, such as by user identification or carrier, and provide in response lists of demands and responses applicable to particular users or carriers. The list screens may include summary information, such as:
a. Date claim activity initiated (demand or response)
b. Initial Party s Claim Number
c. Other Party s Name
d. Other Party s Claim Number
e. Status
f. Original Requested Amount
g. Last Proposed Amount
h. Difference ′ Original to Last Proposed Amount
i. Comments

The tracking/reporting module 460 may further provide functionality for users to design queries to conduct searches through active and historical demands and responses. Tracking/reporting module 460 may also furnish to the user a complete history of a demand or a response.

A maintenance and security module may be provided to permit users to maintain data, including contact data, template data, and rules operations. A security module may restrict access to data on a per user basis, within a carrier, for example.

A Business Intelligence Report module, which may be included in tracking/reporting module 460, may have the functionality of monitoring the progress results of each demand. This module may perform statistical analyses of response progress results, and compare those analyses to business rules employed by triage module 420 for providing response recommendations. Discrepancies may be identified by running comparison rules, and modifications to business rules employed by triage module 420 may be implemented in response to identification of discrepancies. Alternatively, the modifications to business rules may be recommended or proposed to a user prior to being implemented. The modifications based on historical data are to predictive business rules.

The system may permit both batch and real-time processing. Receipt of packets from an interchange may result in output signals being provided to users.

Further modules include a police report module for accessing police reports, running business rules on police reports, comparing police report data to demand data, and providing user flags; a rental module for applying rules for rental cars; and a salvage module, providing functionality as described above.

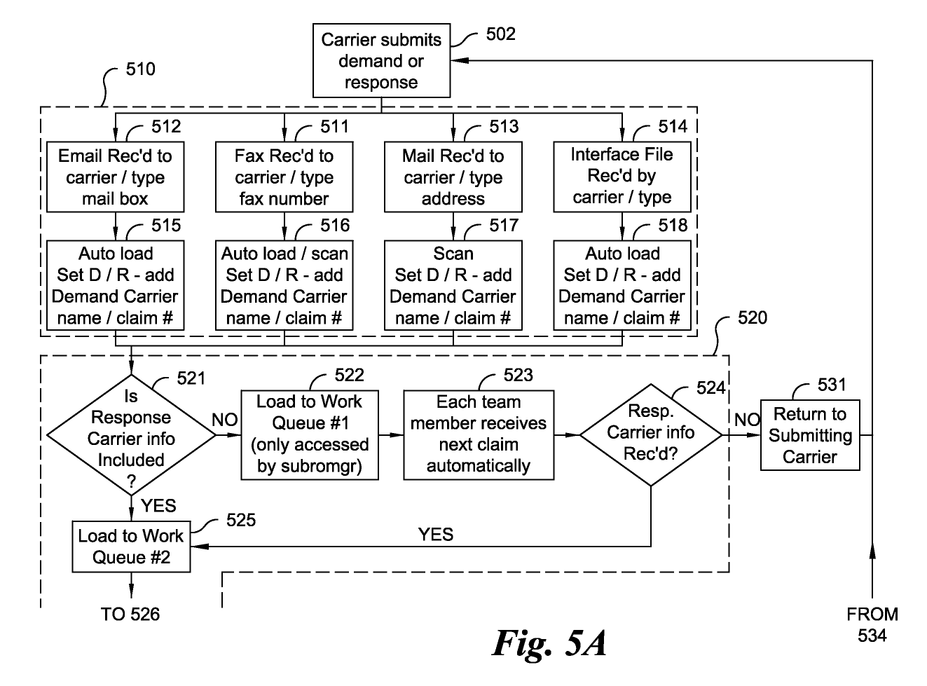

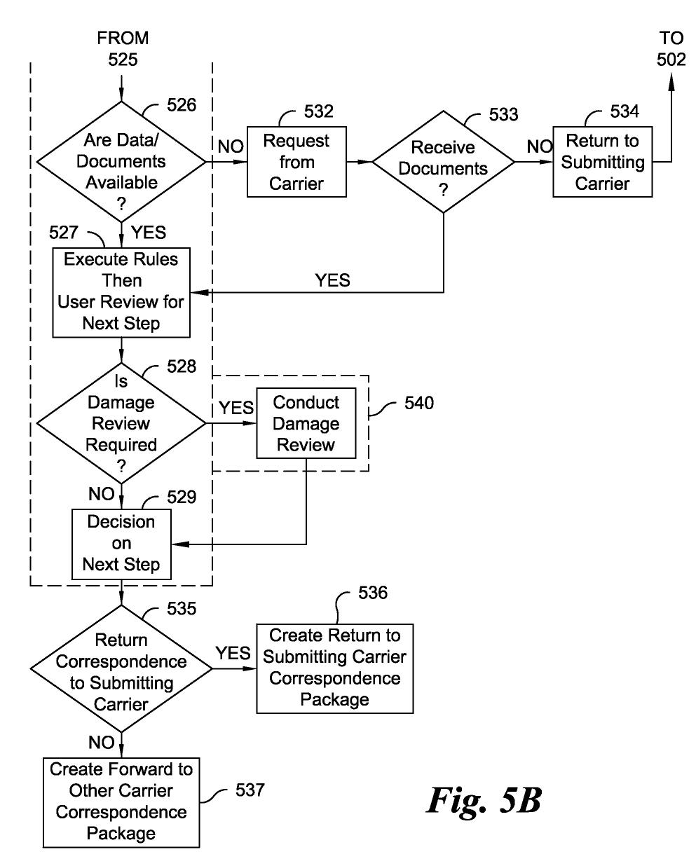

Referring to FIG. 5, a process flow will be described. A carrier submits 502 a demand or response, which is processed 510 by intake module 410. In an embodiment, intake module 410 is in communication with fax and e-mail systems and OCR systems. In an embodiment, separate fax numbers 511, e-mail mailboxes 512, postal mail addresses 513 and file upload destinations 514 are maintained for each one of a number of carriers and a number of types of communications, such as demands and responses to demands. The number of types of communications and separate addresses may be more granular in an embodiment. Email is auto loaded by intake module to create a record. Intake module sets demand or response status and accesses and adds to the record the demand carrier name and claim number 515. Faxes are scanned and converted by OCR and similarly records are created 516. For mail, a scan is performed 517; OCR or user input provides demand/response status and demand carrier name and claim number. For uploaded interface files, the intake module auto loads 518 the record and sets demand or response status and accesses and adds to the record the demand carrier name and claim number.

The triage module 420 assesses the response or demand as indicated by block 520. Presence of response carrier information, such as name, policy number, insured name, and policy state, is checked for completeness 521. The communication may be loaded to a work queue 522 to contact the submitting carrier for information, and the next claim in order is automatically presented to personnel 523. If the response carrier information is not received 524, then the claim is passed to the communications preparation module for preparation of a communication to return the claim to the submitting carrier 531 as lacking sufficient information to process. If the response carrier information is received, either initially or later, then the triage module may load the demand or response to a work queue 525 for further processing. If required data and documents are not available, 526, then the communications preparation module may prepare a request 532 to the submitting carrier. Upon receipt of documents 533, the process flow returns to the triage module. If the documents are not received within a required time, then the communications preparation module prepares a communication to return the demand or response to the submitting carrier 534. When required information has been received, the triage module applies the predictive and regulatory business rules 527, and, based on results of application of the business rules, provides recommendations or a recommendation to the user for the next step. If the next step if for detailed review 528, then the claim is passed to the review module for detailed review 540. After detailed review, if required, the user makes a decision o the next step, which is provided to the system, and the demand or response is passed to the communications preparation module for preparation of communications. If the communication is a return to the submitting carrier 535, such as because the detailed review indicates a lack of information or no liability, then the return to submitting carrier correspondence package, one of the template communications, is created 536. Otherwise, a forward to other carrier correspondence package 537, another one of the template communications, may be created.

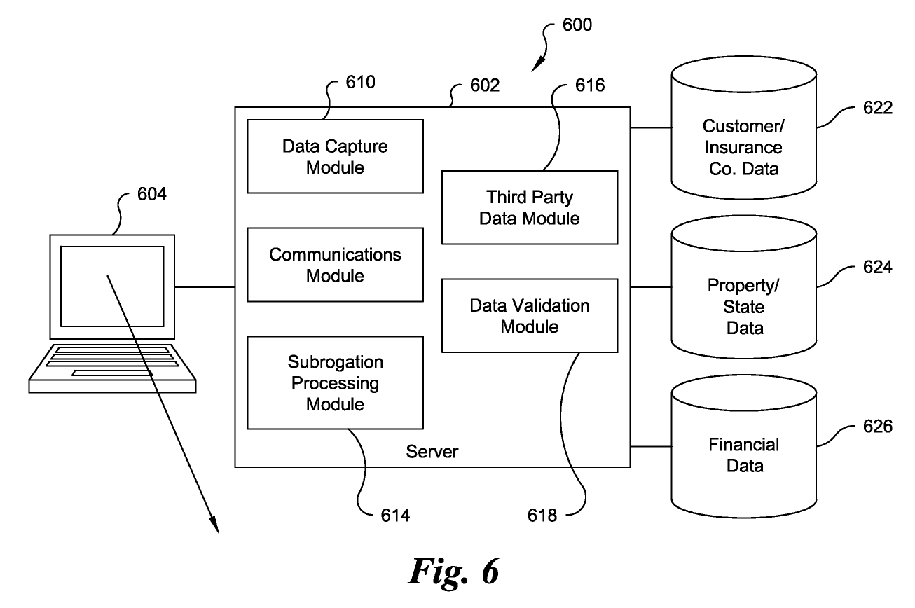

Referring now to FIG. 6, a schematic diagram of a system according to an embodiment is provided. Server 602 communicates with a user device 604. Server 602 may implement modules, including a data capture module 610 for receiving data, such as from forms completed and provided from user device 604, communications module 612, for formatting and providing output signals and for receiving input signals including data and routing data to an appropriate module, a subrogation processing module 614 for performing subrogation related processes as described in the present application; a third party data module 616 for accessing third party sources of information; a data validation module 618 for running data integrity checks on data received and data output by the system; and databases 622, 624 and 626, which may include customer and carrier data 622, property and state data 624, and financial data 626, by way of example.

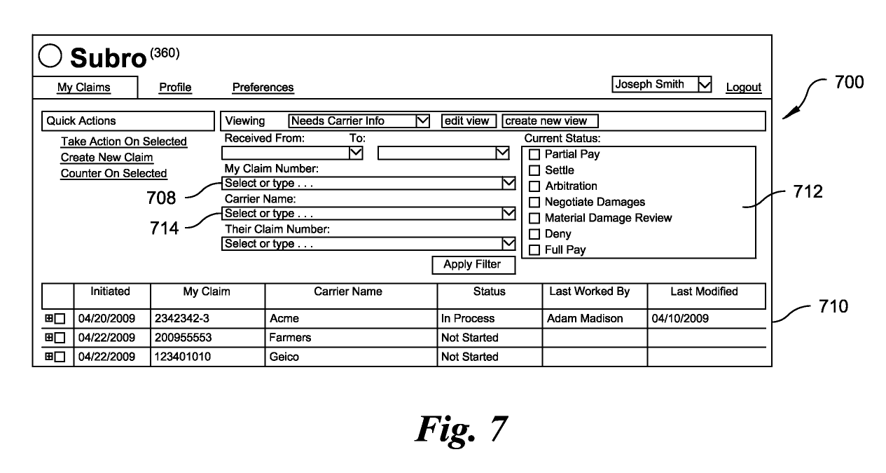

Referring now to FIG. 7, an exemplary screen shot 700 is shown on a user device of a screen presented by a system to a user to illustrate a queue 710 of demand side subrogation claims requiring action. Searches may be conducted by claim number 708, status data 712, carrier data 714, claim type 716, other carrier s claim number, dates, and other data types. The queue may be generated by tracking/reporting module 460, for example. The queue 710 summarizes each claim by a date initiated, a responding carrier s claim number, a demanding carrier s name, a status, an employee of a responding carrier or service who last worked, and a last modified date.

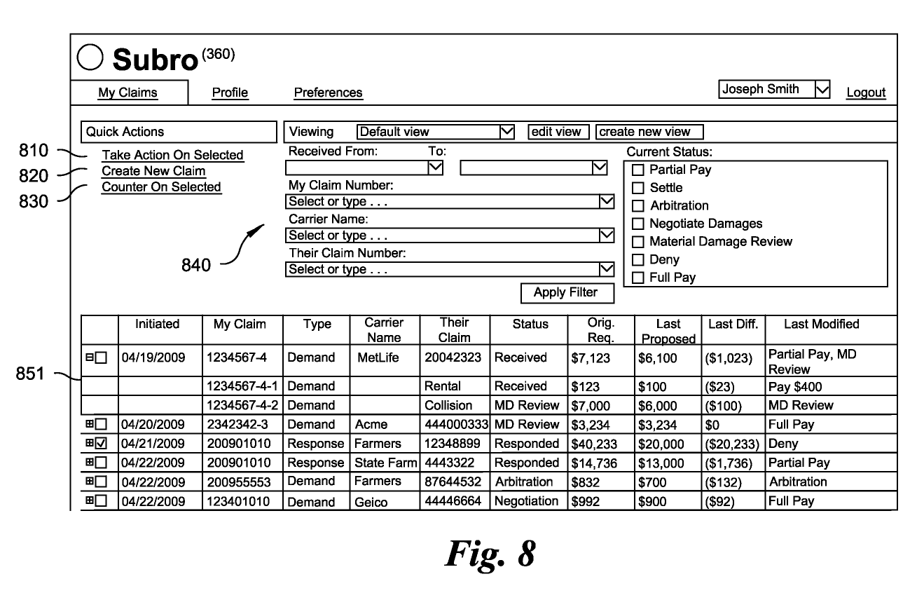

Referring now to FIG. 8, an exemplary screen shot on a user device of a screen presented by a system to a user to permit the user to list pending claims. This list may be generated by tracking/reporting module 460. Once a user logs on, the user will be navigated to this screen. Users may select a claim and the associated action. The action: ‘Take Action on Selected 810 will navigate the user for the selected claim to the next logical screen for the claim. If the entry is incomplete for a claim, the user will be navigated to the entry screen. If the entry is complete for a claim, the user will be navigated to the review screen. ‘Create New claim 820 will navigate the user to a new claim data entry screen. ‘Counter On Selected 830 will navigate the user to the data entry screen to create a new counter demand for the selected claim. When creating a counter demand, information available from the original demand and/or response will be initialized for the counter demand entry. On the My Claims list screen, the user may filter the list of displayed claims through the filtering fields 840 in the top section of the screen. The My Claims List displays the following information:
Date Initiated or added
Claim Number of the carrier signed on (My Claim)
Type ′ Demand or Response (note multiple lines may be display for a single claim)
   Line 1 ′ may be the demand to Carrier B
   Line 2 ′ may be the demand to Carrier C
   Line 3 ′ could be a counter demand received from Carrier C
Carrier Name
Their Claim ′ if multiple loss types are involved, such as by the example at 851:
   Line 1 ′ other carrier s claim number
   Line 2 ′ first loss type
   Line 3 ′ next loss type, and so on for further loss types
Status for each carrier and/or loss type
Original Requested amount for each carrier and/or loss type
Last Proposed amount for each carrier and/or loss type
Last Difference between the Original Requested amount and the Last Proposed amount for each carrier and/or loss type

The comments displays a status value. The system may provide a set of status values to describe various points in the lifecycle of a claim and the type of response outstanding, such as partial pay, settle, arbitration, negotiation, material damage review, denial and full pay.

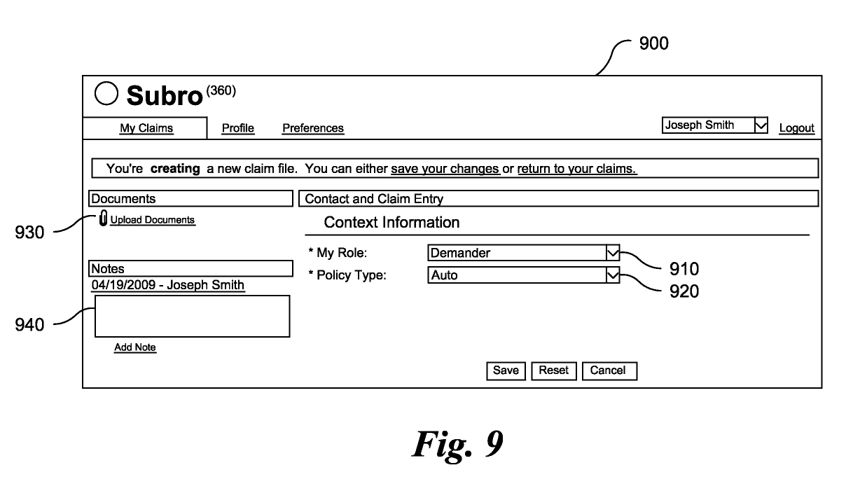

Referring now to FIG. 9, an exemplary screen 900 displayed on a user device by intake module 410 to prompt a user to commence input of a new claim file in the system. The user is presented with a drop down menu 910 from which to select a role, which is either demand or response. A type of insurance policy, such as automotive, may be selected from menu 920. A link 930 is provided to launch a tool to upload documents to a system. Documents may include image files and word processing files of written documents, photographs, such as photographs of damaged property and vehicles, video files of damaged property and other pertinent videos, and audio files of interviews of insureds and other witnesses. A text editor 940 is provided to permit the user to enter text notes regarding the claim. The system stores this data in data storage devices that store data organized in accordance with databases. The relevant fields in a database for records relating to this claim are for storing data related to this claim are determined, in accordance with tables stored in a database or in a database server, based on the selection of demand or response and the policy type.

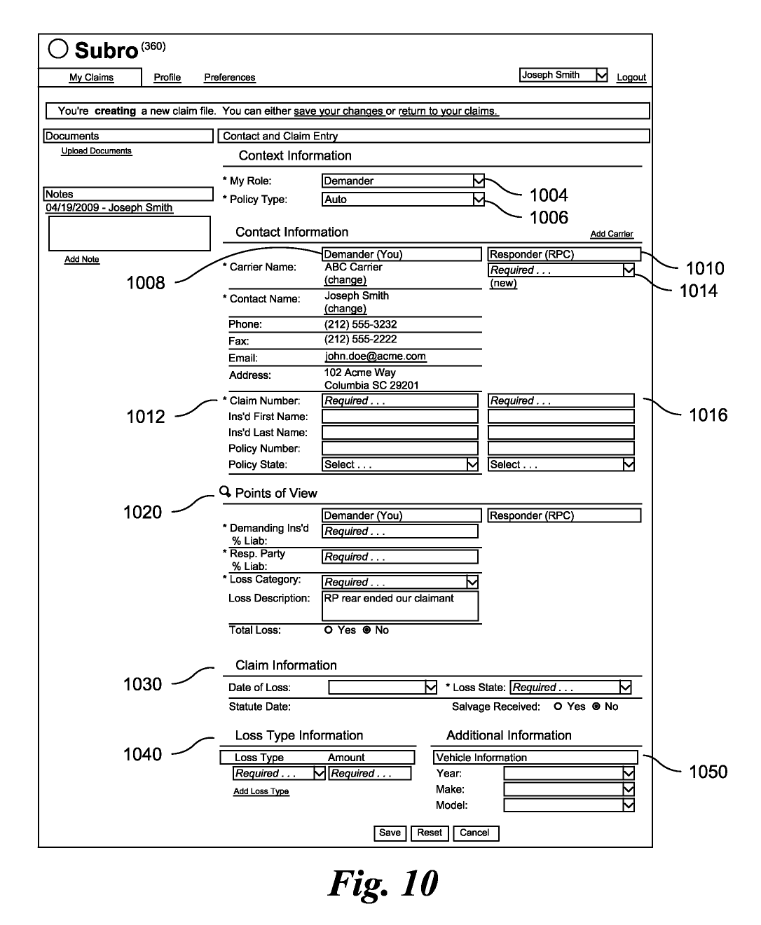

Referring now to FIG. 10, an exemplary screen displayed on a user device by a system, such as by intake module 410, to prompt a user to provide additional information prior to entry of a new claim is provided. In an embodiment, the user may be prompted to select a role, such as demander or responder, at 1004, and a policy type, such as auto, homeowners, or workers compensation, at 1006. The carrier information for the individual entering (or updating) the claim will display in column one 1008. The field header changes from ‘Demander or ‘Responder depending on the type of action or role selected. The user may update the own carrier information, with claim number, first and last name of the insured, policy number and policy state, at 1012. If a demand is being processed, one or more Response carriers may be entered, such as at column 1010. Another screen may be provided to address a multi-response carrier. Data entry associated with the other carrier will be controlled by several factors. For example, a drop down menu 1014 may be provided to select a carrier; the intake module will populate other fields from a database. The responder claim number, insured s first and last names, policy number and state are to be input at 1016. A carrier may update information related to their demand or response as needed. A carrier may only update the other carrier information dependent on the type of transaction ′ demand vs. response, and whether the other carrier has updated information in the subsequent sections. The following information will only be captured for the demand carrier (or on a counter demand): Claim Information and Loss Type Information. The Point of View information, in point of view section 1020 will be maintained for each carrier. Section 1020 includes inputs to receive the demanding carrier s view of: the demanding carrier s percentage of liability, the responding carrier s percentage of liability, a loss category (e.g., in auto insurance, damage and rental), which may be a drop down menu, a loss description, which may be a free text entry, and a selection of whether the loss is total. The fields in point of view section 1020 may be determined by the policy type; for example, loss category drop down choices and the total loss selection may be specific to auto policies.

Claim information section 1030 provides fields for input of a date of the loss, e.g., a date of an automobile accident, a state in which the loss occurred, and whether salvage value has been received. Loss type information section 1040 provides fields for input of loss types and loss amount. A drop down menu may be provided with inputs dependent on policy type. A user option to provide fields of an additional loss type and amount may be provided. Vehicle information section 1050 is generated in response to selection of auto policy type, and provides fields for vehicle year, make and model.

If a counter demand is made, multiple versions of the Point of View information would be maintained by carrier. The Loss Type information section will only display loss types associated with the Policy Type selected, such as collision and rental for auto. The Additional information section will vary by Policy Type. For Auto policies, by way of example, this section will initialize with the vehicle information displayed for entry. If Rental is selected as a loss type, the associated number of days fields will display.

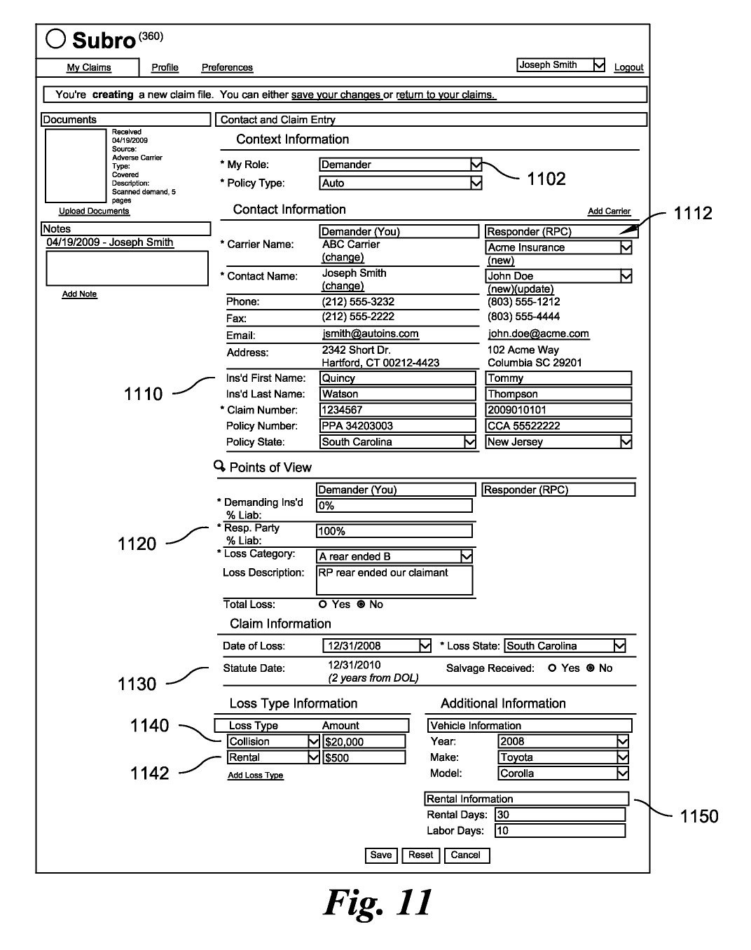

Referring to FIG. 11, an exemplary screen is shown as displayed by the system on a user device after creation of a claim in the system, by a demander. The screen shows certain data extracted from one or more databases and populated in the screen, such as demander and responder data and statute of limitations. Insured information, such as first and last name, demander claim number, policy number and policy state, have been completed at 1110. Responder data 1112 includes company phone, fax and address populated from a system database, and insured first name, last name, claim number, policy number and policy state data input by the user. The percentages of responsibility of the demanding party s insured and responding party s insured have been input at 1120. Collision 1140 and Rental 1142 loss types have been selected, along with corresponding amounts. Responsive to selection of rental loss type, the intake module has displayed Rental Information section/fields 1150, including rental days and labor days entries. If the entry is being input by the Demand carrier, the Responder Points of View will not be available for entry. If initial entry is made by the Response carrier (for both the demand and response side), the Demand carrier Points of View will be available for entry. The Statute Date 1130 is calculated employing regulatory business rules, and will be displayed only responsive to input of both the Date of Loss and Loss State. Beneath the date, the rule applied will also display (number of years from the date of loss). No statute date will display if the Loss State is not available in the Statute date table (i.e., foreign country provinces or states). During initial entry, the ‘Role type 1102 can be updated. Once a demand or response have been saved by the intake module into a database, this field will not allow updating.

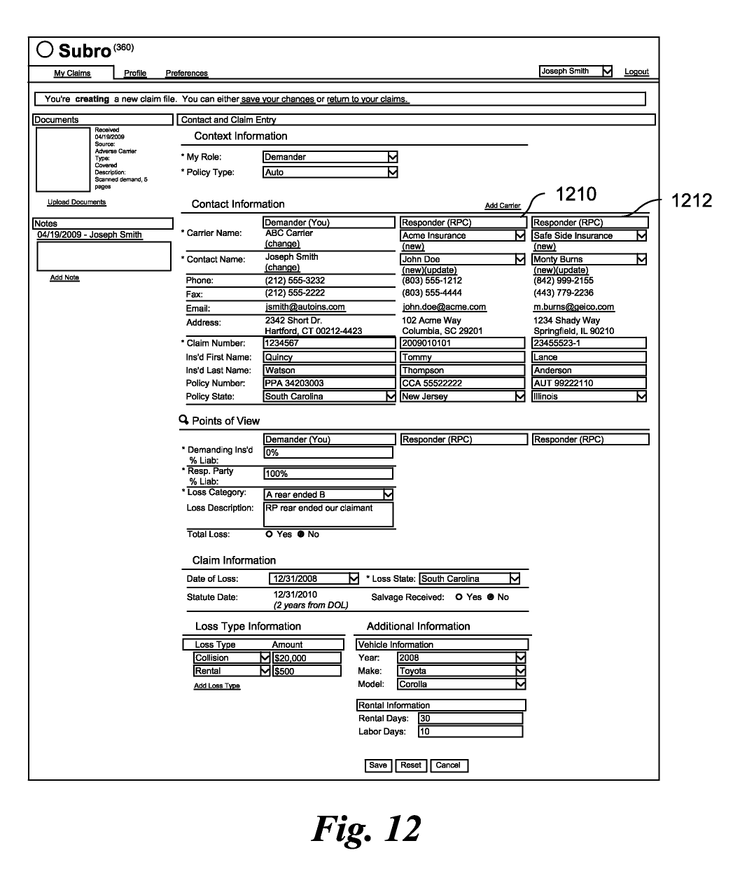

Referring to FIG. 12, an exemplary screen is shown as displayed by the system on a user device after creation of a claim in the system having multiple carriers 1210, 1212, in a responder role. The screen of FIG. 12 is similar to the screen of FIG. 11, with only the data for second responder carrier 1212 being added. The name and contact individual are input by the user, and the intake module accesses a database of carrier address and contact information to populate fields for phone, fax, email and postal addresses. As with the other carrier, the user may fill fields for claim number, insured first and last names, carrier policy number and carrier policy state.

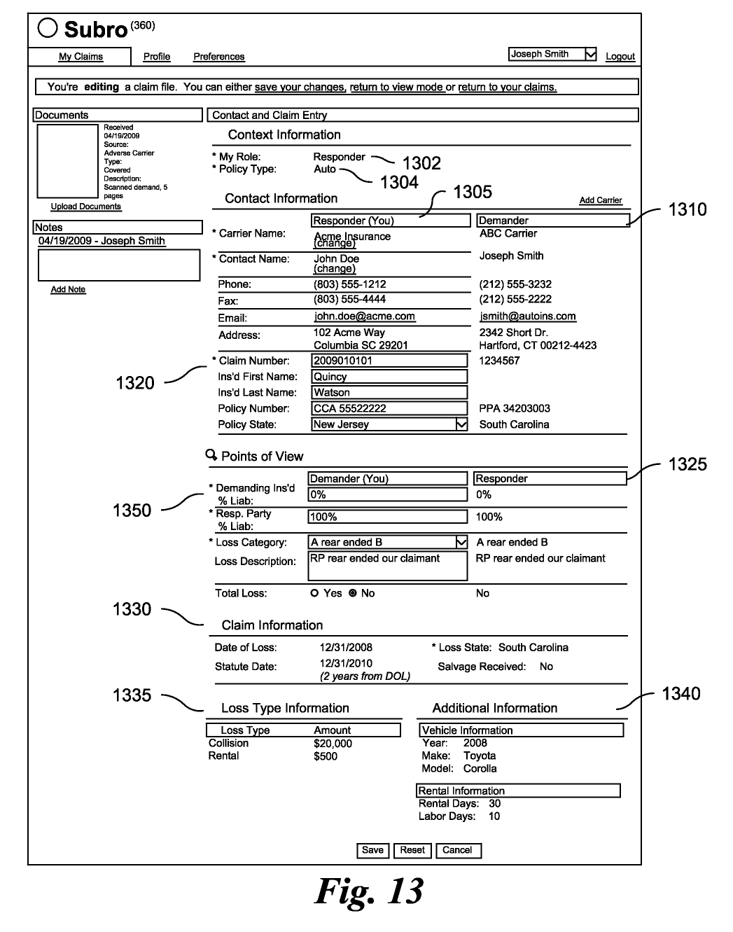

Referring to FIG. 13, an exemplary screen is shown as displayed by a system on a user device showing a view presented to a representative of a carrier in the role of responder. When the alternate carrier (in this example the Responder) views the claim, their information will display in the first column 1305. The role 1302 and policy type 1304 are fixed. The initial carrier s (in this example the Demander) information 1310 will display as inquiry only, i.e., the system will not accept updates from the responder for the following demander information:
Contact Information
Point of View Information 1325
Claim Information 1330
Loss Type Information 1335
Additional Information 1340, including, in this case, vehicle and rental information
   The alternative (responder) carrier may update the following information
Contact Information
Point of View Information 1325, including the responsibility percentages of the respective insureds, the loss category, the loss description, and whether the loss is total.
   The responder s claim number, insured first and last name, policy number and policy state may be updated.

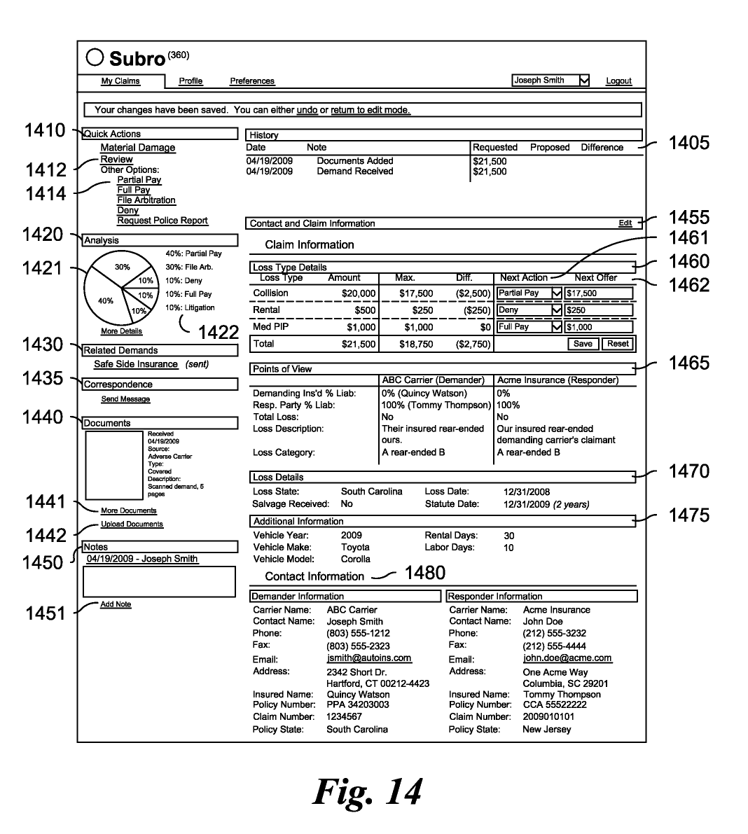

Referring to FIG. 14, a screen display is shown as an example of a screen display, referred to as review screen, presented to a user after a claim has been opened and business rules have been run on the claim. This screen is presented by triage module 420. For example, the business rules run by the triage module have caused the system to access similar claims. The Quick Actions section 1410 displays the recommended potential next action 1412 first in bold. Additional available actions 1414 are also displayed. The actions include: Partial Pay, Full Pay, Material Damage Review, File Arbitration, Deny, and Request Police Report. As described above, the triage module applies business rules to received loss event data, such as the data entered in the screens described above, with a recommended course of action being determined and displayed responsive to the application of the business rules to the loss event data. The actions available will also be impacted by the number of loss types and their associated suggested actions. For example, if both Collision & Rental suggested actions were Partial Pay, the global action would be Partial Pay. If Collision were Full Pay and Rental were Partial Pay ′ the global action would be Partial Pay.

The analysis section 1420 displays prior results for the other carrier, for a selected time period, as well as optionally based on other filters. The results may be filtered according to one or more of:
Carrier
Policy Type
Loss Category
Loss State
   Outcome categories may include:
Party Pay
Full Pay
Deny
Arbitration Filed
Litigation
   Both a graphic display 1421 of the percentages of outcome categories, and a numerical display 1422 are provided.

The related demands section 1430 displays, if multiple demands have been filed for a claim, the associated demand Carrier name(s) as links. When the user selects the carrier name, the user will be navigated to the Summary screen for that demand/counter demand. The Correspondence section 1435 displays prior correspondence sent to the carrier displayed on the screen. If multiple Response carriers are involved in a claim, the associated Correspondence will display once the carrier has been selected for viewing. Initiation of new Correspondence may be invoked within this section. The Documents section 1440 displays 1-4 documents, and additional documents will be displayed on the Documents view screen. A summary of pertinent information regarding each displayed document, such as date of receipt or dispatch, the source of the document, a type of document, such as demand, response, or police report, and a description of the document, including a length. The More Documents link 1441 displays in this section. This link navigates the user to the full Documents view screen. The Upload Documents link 1442 displays in this section. This link invokes the upload documents function, which permits the user to associate documents with the claim.

The Notes section 1450 displays 1-3 notes; additional notes may be displayed on the Notes view screen. The More Notes link displays in this section, if there are more notes associated with the claim. This link navigates the user to the full Notes view screen. The Add Notes link 1451 displays in this section. This link invokes the Add Note function.

The Edit Link 1455 navigates the user to the Data Entry screen for updates to the Claim Information. The History section 1405 will display prior activities on the claim. The display elements include:
Date (of the activity)
Note (generated description for the activity)
Requested Dollars ′ original demand dollars for the claim
Proposed Dollars ′ proposed response dollars for that action
Difference Dollars ′ difference between the original demand and the associated proposed dollars
   The Loss Type Details section 1460 displays the following information for each of the demanding carrier s loss types
Loss Type
Demand amount
Maximum suggested amount for the response carrier
Difference between the Demand amount and the Maximum amount
   The user may update the following information by Loss Type:
Next Action 1461, which will default, if possible, to the suggested next action by loss type
Next Offer, which is a dollar amount.
   The Points of View section 1465 displays each carrier s point of view for the following information:
Demanding Party s Insured Percentage of Liability
Responsible Party s Percentage of Liability
Total Loss ′ whether the loss is defined as a total loss by the carrier
Loss Category
Loss Description

If multiple response carriers exist for a demand carrier, links will display to review the other carriers. The Loss Details section 1470 displays the summary level claim information. The Additional Information section displays information dependent on Policy Type and Loss Type. In the example of FIG. 14, Vehicle information displays as this is an Auto Policy Type, and Number of Days display as Rental loss type was selected on this claim. The contact section 1480 displays both demand and response carrier: Contact information, Policy and claim numbers and insured names.

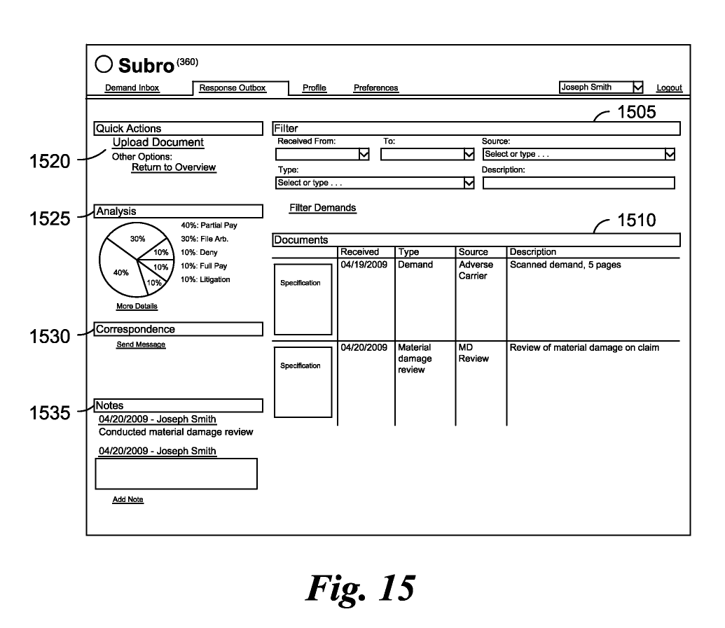

Referring now to FIG. 15, an exemplary screen is shown which may be displayed on a client device by a system to show individual documents related to a claim, and data associated with the data stored in one or more databases. If the ‘More Documents link is selected, the user will be navigated to the Documents Screen. The screen includes a filter section 1505, which permits searches to made by sender, recipient, source, type and description of a document. For each selected document, the screen displays in document section 1510 the following:
Thumbnail view of the first page of the document
Date document was received/added to the system
Type of Document, such as demand, material damage review, police report, or other correspondence
Source of the document, such as an adverse carrier
Description of the document
   The user has the option to invoke the upload document function 1520. The analysis section 1525 displays a summary of the likelihood of various outcomes based on a review of similar claims in historical records in the database. Correspondence section 1530 permits a user to send a message related to the claim. Notes section 1535 permits a user to review and create notes related to the claim.

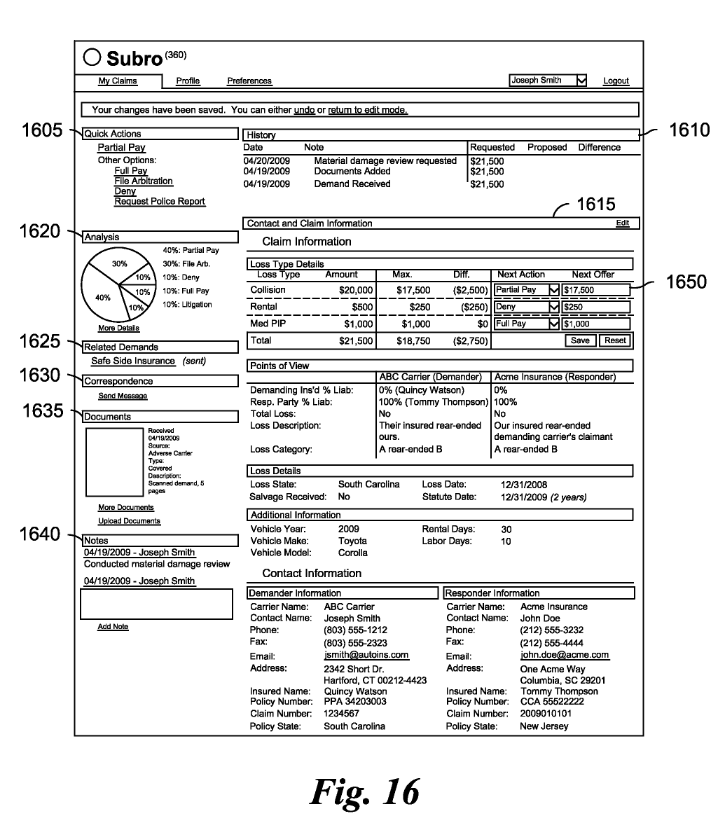

Referring to FIG. 16, a screen displayed by a system on a user device to receive an indication from a user to provide a next offer in the negotiations is shown. The quick actions section 1605 permits the user to initiate an action by clicking on one of the selected available actions. The recommended action resulting from application of the business rules to the loss event data, which action is ‘partial pay in this example, is displayed prominently, although the user has the option of selecting other available options. Selection of the option will initiate a communications preparation module to commence preparation of a communication. Other sections displayed, including history 1610, contact and claim information 1615, analysis section 1620, related demands 1625, correspondence 1630, documents 1635 and notes 1640 are similar to those described in FIG. 14. The amount of a partial pay offer 1650 may be displayed.

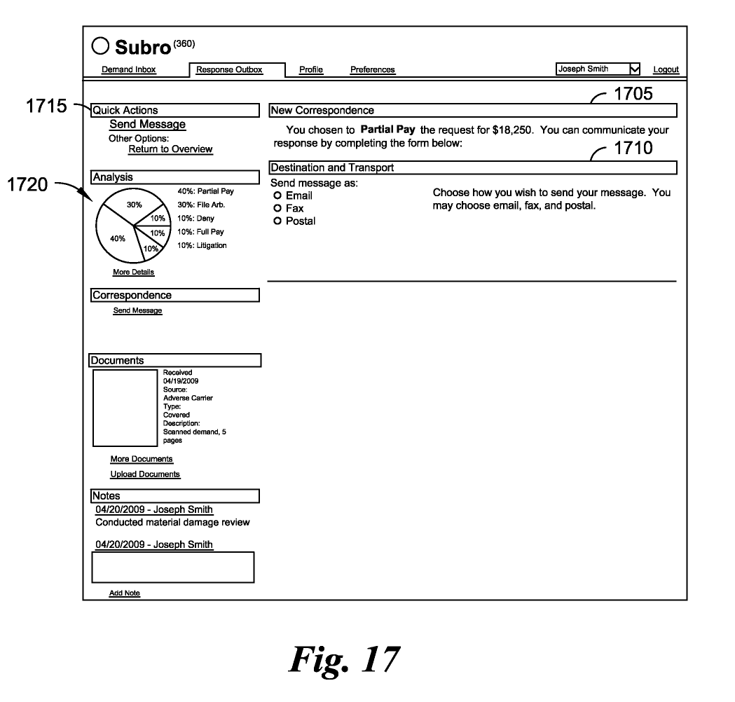

Referring to FIG. 17, a screen displayed by a system on a user device to prompt a user to select a communications mode for an exemplary response is shown. The screen may be generated by a communications preparation module. Selection of the response mode invokes the response preparation module. The new correspondence section 1705 summarizes the action selected from the screen shown in FIG. 16. The destination and transport section 1710 permits a user to select available transmission modes, such as email, fax and postal mail. Other transmission modes, such as posting to a communications environment, may also be available. A quick action section 1615 permits a user to send a message, such as by linking to a write e-mail function in an e-mail client. The screen displays functions 1620 as does FIG. 15, for example.

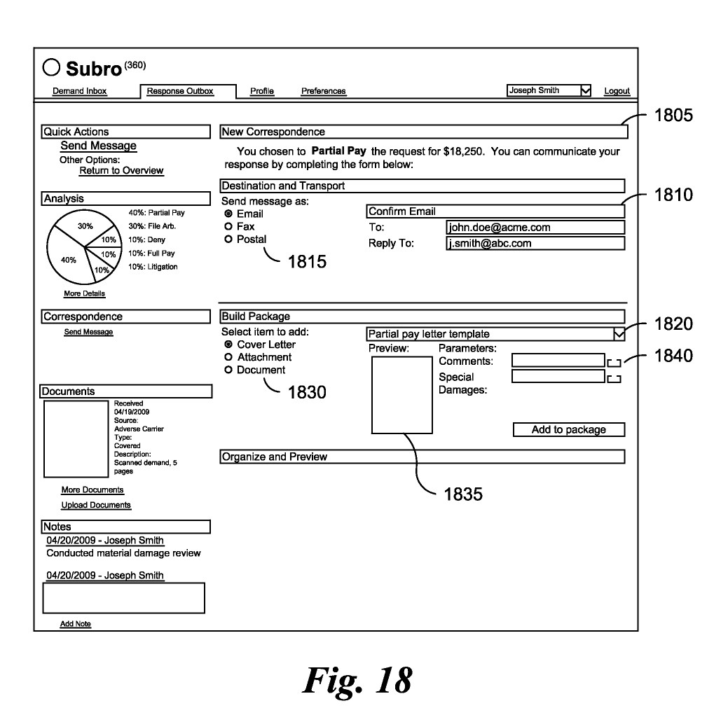

Referring to FIG. 18, a screen displayed by a system on a user device by a communications preparation module of a system is shown. The communications preparation module includes in the screen a summary in the new correspondence section 1805, prompts the user to confirm or provide address information in the confirm email section 1810. If another communications mode 1815 had been selected, the user would be prompted to provide or confirm a fax number or postal mail address. The user is provided with a drop down menu 1820 of template communications, which may be in the form of packages having certain types of documents. The response preparation module may select a limited set of template communications, such as packages (e.g., the partial pay letter template), appropriate for the action, such as a partial pay, and the type of policy, such as automotive, from a larger set of template communications. The screen may prompt the user to add categories of items at 1830, display a preview 1835 of a first page of a document, and permit a user to select parameters 1840 such as comments and special damages.

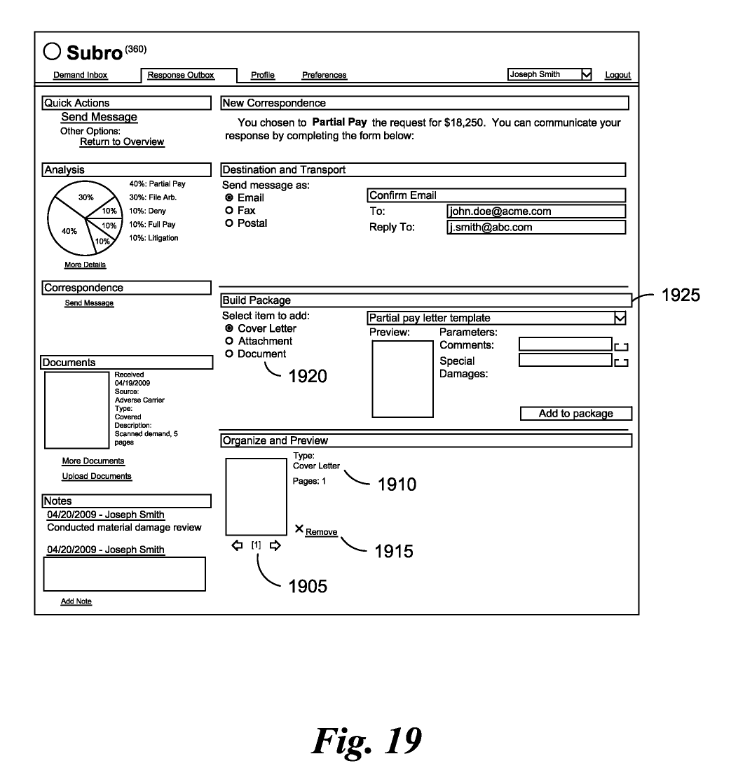

Referring now to FIG. 19, a screen is shown, displayed by a system on a user device by a response preparation module of a system, showing a preview of a cover letter 1905 selected by a user. A communication type 1910 and a removal option 1915 are provided. As the user adds items, from the items available at 1920, the items may be selected and previewed in build package section 1925. The user may add items, such as documents and attachments to the cover letter. For example, police reports, witness statements, body shop estimates, adjuster s reports, and other documents to buttress a claim or provide support for a response may be selected. Once the package is complete, the user may send the package. FIG. 19 is otherwise similar to FIG. 18.

An exemplary architecture for implementing a system of the invention includes java-based code in the following tiers:
a. User Interface (UI)—Implemented with Java Server Faces (JSF)
b. Business Logic Layer (BLL)—Implemented using EJB3 to provide a java-based service oriented architecture.
c. Data Access Layer (DAL)
   i. EJB3 Entity Beans
   ii. Hibernate Persistence Provider
d. Oracle Database

Additionally, a rules-engine and a workflow engine support the implementation of business rules in the Business Logic Layer.

Although embodiments of features such as workflows, screen displays, hardware architecture and software architecture have been illustrated, these are non-limiting embodiments.

In embodiments, business rules, such as business rules embodied in a business logic layer employing a Java-based architecture, may include as variables identities of carriers, state or other location of claims, type of claim (e.g., automobile, real property, personal property other than automobile, or other claim), remediation information (e.g., car rental information, property repair information), amounts of claims expressed in currency, information obtained from police reports or other information available from government sources, information provided by adjusters and/or estimators, type of loss, liability percentages, salvage information, and other information. The business rules may be updated and modified automatically based on claim data received and stored by the system. The business rules may provide for rules for determining whether one or more stored claims are similar, identifying in a memory similar claims, determining results for similar claims, and basing a recommendation for action based in whole or in part on results for the identified similar claims. The business rules may provide for display to a user of summaries of results for identified similar claims.

Although specific hardware and data configurations have been described herein, not that any number of other configurations may be provided in accordance with embodiments of the present invention (e.g., some of the information associated with the databases described herein may be combined or stored in external systems). Moreover, although examples of specific types of claims involving automobile losses have been used, embodiments of the present invention could be used with other types of claims.

The present invention is operable with computer storage products or computer readable media that contain program code for causing a processor to perform the various computer-implemented operations. The computer-readable medium is any data storage device that can store data which can thereafter be read by a computer system such as a microprocessor. The media and program code may be those specially designed and constructed for the purposes of the present invention, or they may be of the kind well known to those of ordinary skill in the computer software arts. Examples of computer-readable media include, but are not limited to magnetic media such as hard disks, floppy disks, and magnetic tape; optical media such as CD-ROM disks; magneto-optical media; and specially configured hardware devices such as application-specific integrated circuits (ASICs), programmable logic devices (PLDs), and ROM and RAM devices. Examples of program code include both machine code, as produced, for example, by a compiler, or files containing higher-level code that may be executed using an interpreter. Steps in the computer-implemented methods may be implemented in processors running software stored locally, and/or in configurations such as application service providers, in which certain steps are executed on processors communicating with one another over a network such as the Internet. Either stand-alone computers or client/server systems, or any combination thereof, may be employed.

A system in accordance with the invention may include means corresponding to each step in each method described herein. Each means may be implemented by a processor executing instructions contained in programs which may be stored in a storage medium and loaded into random access memory for execution. It will be appreciated that any of the steps in the methods in accordance with the invention described herein may be so implemented.

An exemplary advantage of a system and method in accordance with an embodiment is that insurance carriers may prepare and respond to demands in a consistent manner, with ready access to historical data for use by predictive business rules to generate recommendations, as well as access to regulatory business rules to assure compliance with legal obligations. Furthermore, an embodiment has the exemplary advantages of facilitating verification of information regarding claims, facilitating detailed review of claims and simplified preparation of responses.

While the foregoing invention has been described with reference to the above embodiments, various modifications and changes can be made without departing from the spirit of the invention. Accordingly, all such modifications and changes are considered to be within the scope of the appended claims.

What is claimed is:

1. A computer system for administering a subrogation transaction related to a loss event, comprising:
a processor;
a memory storage device in communication with the processor;
the processor configured to:
access from the memory storage device data relating to the loss event;
perform subrogation related calculations based on the accessed loss event data and responsive to a first regulatory business rule and a first predictive business rule;
determine, based on the calculations, a recommendation for a communication between insurance carriers including at least an amount
provide an output signal for display of the recommendation on a user-accessible device.

2. The computer system of claim 1, wherein the loss event is an automobile accident.

3. The computer system of claim 1, wherein the recommendation is for a communication comprising a demand for payment in the amount.

4. The computer system of claim 1, wherein the communication comprises a response to a demand for payment.

5. The computer system of claim 1, wherein the underlying event comprises an event resulting in at least one of personal injury and damage to real property.

6. The computer system of claim 1, wherein the processor is further configured to determine and display for a user relative proportions of a plurality of outcomes of subrogation transactions similar to the subrogation transaction.

7. The computer system of claim 6, wherein the outcomes comprise full payment, partial payment, denial and litigation.

8. The computer system of claim 6, wherein the processor is further configured to determine similarity of subrogation transactions based on a plurality of factors including an identity of a carrier.

9. A computer system for administration of subrogation related transactions based on associated loss events, comprising:
an intake module configured to receive data relating to the loss events;
a triage module configured to run regulatory business rules and predictive business rules on the received loss event data and provide recommendations to a user based on results of running the business rules;
a communications preparation module configured to prompt a user to select template communications and provide inputs including data based on the received loss event data to create outgoing communications; and
a communications transmit module to transmit the outgoing communications.

10. The computer system of claim 9, wherein the triage module is configured to display statistics indicative of responses to similar claims from a same carrier.

11. The computer system of claim 9, wherein the recommendations displayed for a response to a demand comprise partial pay, full pay, file arbitration and deny.

12. The computer system of claim 11, wherein the template communications include template communications for each of the partial pay, full pay and deny responses.

13. The computer system of claim 9, wherein the communications transmit module is configured to transmit the outgoing communications by any one of e-mail, fax and printed postal mail.

14. The computer system of claim 9 wherein the predictive business rules comprise rules for application in response to a demand for determining likelihood of liability, quality of documentation supporting a claim, and carrier history.

15. The computer system of claim 9, wherein the predictive business rules comprise rules for application in preparation of a demand for determining likelihood of potential carrier responses.

16. The computer system of claim 9, wherein the regulatory business rules comprise rules for application of state statutes of limitations.

17. The computer system of claim 9, further comprising a review module configured to provide resources for review of a claim.

18. The computer system of claim 17, wherein the resources comprise a salvage module configured to determining salvage value of a damaged automobile.

19. A computer-implemented method for administering subrogation related transactions involving loss events, comprising:
receiving data relating to at least one of the loss events by an intake module, and storing the received loss event data in a database;
applying regulatory business rules and predictive business rules to the received loss event data, and providing, based on results of the applying, recommendations to a user, by a triage module;
creating outgoing communications based in part on the loss event data, by a communications preparation module; and
transmitting the outgoing communications by a communications transmit module.

20. The method of claim 19, further comprising displaying by the triage module statistics indicative of responses to similar claims from a same carrier.

21. The method of claim 19, wherein the recommendations for response to a demand comprise partial pay, full pay, file arbitration and deny.

22. The method of claim 21, further comprising prompting, by the communications preparation module, the user to select one of a plurality of template communications, the template communications including template communications for each of the partial pay, full pay and deny responses.

23. The method of claim 19, further comprising transmitting the outgoing communications by the communications transmit module by any one of e-mail, fax and printed postal mail.

24. The method of claim 19, wherein the predictive business rules include rules for determining likelihood of liability.

25. The method of claim 19, wherein the predictive business rules include rules for determining quality of documentation of a demand.

26. The method of claim 19, wherein the regulatory business rules comprise caps on liability under state law.

27. The method of claim 19, further comprising providing resources for user review of a claim by a review module.

28. The method of claim 27, wherein the resources comprise a module configured to assess a cost of repair of damaged property.

29. A computer-readable medium for processing subrogation related transactions having a plurality of instructions thereon which, when executed by a processor, cause the processor to:
receive data relating to a loss event and store the received data in a database;
access the received data, apply to the received data regulatory business rules and predictive business rules, and, based on an outcome of the application of the business rules, provide at least one recommendation related to the loss event to a user, the recommendation including at least a proposed payment amount;
prompt a user to select a template communication and provide data for populating fields in the selected template communication, the provided data based on the received loss event data, to create an outgoing communication; and
transmit the outgoing communication.

30. The computer-readable medium of claim 29 wherein the received data comprises a demand, and the instructions further cause the processor to display statistics indicative of responses to similar demands from a same carrier.

31. The computer-readable medium of claim 30, wherein the statistics comprise percentages of partial payment, arbitration, denial, full payment and litigation.

32. The computer-readable medium of claim 29, wherein the recommendations comprise a demand, and the proposed payment amount comprises a demand for payment.

33. The computer-readable medium of claim 29, wherein the instructions further cause the processor to receive a role type and a policy type, and to prompt the user for additional information selectively based on the received role type and policy type.

34. The computer-readable medium of claim 34, wherein the role types comprise demand role and response role.

35. A computer system for processing of demand side subrogation transactions, comprising:
an intake module configured to receive data relating to a loss event, the data including at least a responding carrier;
a triage module configured to apply regulatory business rules and predictive business rules to the received loss event data and provide recommendations to a user for preparation of a demand to the responding carrier based on results of running the business rules;
a communications preparation module configured to prompt a user to select template communications and populate the selected template communications with data based on the received loss event data to create outgoing communications, the outgoing communications including at least demands; and
a communications transmit module to transmit the outgoing communications.

36. The computer system of claim 35, wherein the communications preparation module is further configured to format the outgoing communications in accordance with selected document protocols and format attributes.

37. The computer system of claim 35, wherein the intake module is further configured to access sources of data for verification and augmentation of the received loss event data.

38. The computer system of claim 35, wherein the intake module is further configured to receive documents, and the communications preparation module is further configured to access the received documents and to include one or more of the documents in the outgoing communications.

39. The computer system of claim 35, wherein the recommendations include a demand amount.

40. A computer system for processing of response side subrogation transactions, comprising:
an intake module configured to receive data relating to a demand, the data including loss event data and a demanding carrier;
a triage module configured to apply regulatory business rules and predictive business rules to the received demand data and provide recommendations to a user for preparation of a response based on results of applying the business rules;
a communications preparation module configured to prompt a user to select template communications and populate the selected template communications with data based on the received loss event data to create responses; and
a response transmit module to transmit the responses.

41. The computer system of claim 40, further including a review module for accessing sources of data for use in preparing a response.

42. The computer system of claim 41, wherein application of the business rules comprises use of data accessed by the review module.

43. The computer system of claim 41, wherein the sources of data comprise telematics data.

44. The computer system of claim 40, wherein the predictive rules comprise at least one rule for identifying indications of potential fraud, and the triage module is configured to display a visual indication of potential fraud on a user device in response to application of the identification of potential fraud.

45. A computer system for administration of subrogation related transactions based on associated loss events, comprising:
an intake module configured to receive data relating to the loss events;
a triage module configured to run regulatory business rules and predictive business rules on the received loss event data and provide recommendations to a user based on results of running the business rules;
a communications preparation module configured to create outgoing communications;
a communications transmit module configured to transmit the outgoing communications; and
a monitoring module configured to store subrogation related transaction data, review response results, compare response results to results expected according to application of the business rules, and generate recommendations for updating the business rules based on the monitored response results.

46. The computer system of claim 45, wherein the monitoring module is configured to store results of demands and responses.

47. The computer system of claim 45, wherein the monitoring module is configured to compare response results to results expected according to application of the predictive business rules.

48. The computer system of claim 45, wherein the monitoring module is further configured to compare carrier behavior as predicted by one or more predictive business rules to experienced carrier behavior.

49. A computer system for providing subrogation related carrier responsibility dispute assertion and resolution services on behalf of at least first and second carriers, comprising:
a communications module configured to communicate with client devices associated with at least said first and second carriers;
an intake module configured to receive data relating to the loss events from the client devices;
a triage module configured to apply regulatory business rules and predictive business rules on the received loss event data and provide recommendations for display to a user on the client devices based on results of application of the business rules;
a communications preparation module configured to create outgoing communications related to the loss events; and
a communications transmit module configured to transmit the outgoing communications.

50. The system of claim 49, further comprising:
a monitoring module configured to store subrogation related transaction data, review response results, compare response results to results expected according to application of the business rules, and generate recommendations for updating the business rules based on the monitored response results.

51. The system of claim 49, wherein the intake module is configured to receive and store in a data storage device image files, video files and sound files.
